(19) United States
(12) Patent Application Publication
(10) Pub. No.: US 2018/0132203 A1
(43) Pub. Date: May 10, 2018

(54) LOCATION DETECTION USING RADIO SIGNAL CAPABILITIES

(71) Applicant: NOKIA TECHNOLOGIES OY, Espoo (FI)

(72) Inventors: Robert SAXON, Fox River Grove, IL (US); Zhilan XIONG, Bristol (GB); Nancy LEE, Maplewood, NJ (US)

(21) Appl. No.: 15/799,203

(22) Filed: Oct. 31, 2017

Related U.S. Application Data
(60) Provisional application No. 62/417,765, filed on Nov. 4, 2016.

(51) Int. Cl. H04W 64/00

(52) U.S. Cl. CPC H04W 64/00; G01S 5/0236

(57) ABSTRACT

Various communication systems may benefit from improved positioning technology. For example, communication systems may benefit from taking into account radio signal capabilities of the user equipment when determining the position of the user equipment. A method may include sending a request from a network entity to a user equipment. The method may also include receiving a response to the request from the user equipment. The response may include information about radio signal capabilities of the user equipment. In addition, the method may include determining location assistance data based on the received radio signal capabilities.

### CROSS REFERENCE TO RELATED APPLICATION

This application claims priority to U.S. Provisional Patent Application No. 62/417,765 filed on Nov. 4, 2016. The entire content of the above-referenced application is hereby incorporated by reference.

### BACKGROUND

### Field

Various communication systems may benefit from improved positioning technology. For example, communication systems may benefit from taking into account radio signal capabilities of the user equipment when determining the position of the user equipment.

### Description of the Related Art

Third generation partnership project (3GPP) Universal Mobile Telecommunications Systems (UMTS), such as Long Term Evolution (LTE) and LTE advanced (LTE-A), utilize cellular positioning technology. One such positioning technology is Observed Time Difference of Arrival (OTDOA). OTDOA allows a user equipment to measure time offsets between a serving cell and neighbor cells heard by the user equipment. These offset time measurements are referred to as a reference signal time difference (RSTD). RSTD is a time difference value, whose units are converted and encoded in meters. A location or a position of the user equipment location is then computed from the RSTD measurements using a hyperbolic multilateration algorithm.

To improve the accuracy of the timing measurements taken by the user equipment, a positioning reference signal (PRS) is used. PRSs are dedicated physical signals that are transmitted to the user equipment from at least one serving base station and at least one neighboring base station. The UE uses the PRSs to improve the accuracy of the RSTD measurements. In general, the more accurate the timing measurements are, the more accurate the position calculation. Because OTDOA performance improves as PRS bandwidth increases, existing mobile networks configure wide PRS bandwidth. In current mobile systems, such as LTE, all user devices are presumed to be capable of supporting the full system bandwidth.

5th generation (5G) technology is a new generation of radio systems that provides a common core for multiple services, including Internet of Things (IoT). IoT provides for heterogeneous devices with varying bandwidth capabilities. Specifically, IoT devices are designed to utilize low bandwidth access methods in order to reduce radio frequency (RF) load and to improve battery life.

### SUMMARY

According to certain embodiments, an apparatus may include at least one memory including computer program code, and at least one processor. The at least one memory and the computer program code may be configured, with the at least one processor, to cause the apparatus at least to send a request from a network entity to a user equipment. The at least one memory and the computer program code may also be configured, with the at least one processor, to cause the apparatus at least to receive a response to the request from the user equipment. The response may comprise information about radio signal capabilities of the user equipment. In addition, the at least one memory and the computer program code may be configured, with the at least one processor, to cause the apparatus at least to determine location assistance data based on the received radio signal capabilities.

A method, in certain embodiments, may include sending a request from a network entity to a user equipment. The method may also include receiving a response to the request from the user equipment. The response may comprise information about radio signal capabilities of the user equipment. In addition, the method includes determining location assistance data based on the received radio signal capabilities.

An apparatus, in certain embodiments, may include means for sending a request from a network entity to a user equipment. The apparatus may also include means for receiving a response to the request from the user equipment. The response may comprise information about radio signal capabilities of the user equipment. In addition, the apparatus may include means for determining location assistance data based on the received radio signal capabilities.

According to certain embodiments, a non-transitory computer-readable medium encoding instructions that, when executed in hardware, perform a process. The process may include sending a request from a network entity to a user equipment. The process may also include receiving a response to the request from the user equipment. The response may comprise information about radio signal capabilities of the user equipment. In addition, the process may include determining location assistance data based on the received radio signal capabilities.

According to certain other embodiments, a computer program product may encode instructions for performing a process. The process may include sending a request from a network entity to a user equipment. The process may also include receiving a response to the request from the user equipment. The response may comprise information about radio signal capabilities of the user equipment. In addition, the process may include determining location assistance data based on the received radio signal capabilities.

According to certain embodiments, an apparatus may include at least one memory including computer program code, and at least one processor. The at least one memory and the computer program code may be configured, with the at least one processor, to cause the apparatus at least to receive a request at a user equipment from a network entity. The at least one memory and the computer program code may also be configured, with the at least one processor, to cause the apparatus at least to send from the user equipment a response to the request. The response may comprise information about radio signal capabilities of the user equipment. In addition, the at least one memory and the computer program code may be configured, with the at least one processor, to cause the apparatus at least to receive location assistance data from the network entity based on the sent radio signal capabilities. Further, the at least one memory and the computer program code may be configured, with the at least one processor, to cause the apparatus at least to determine signal measurements at the user equipment based on the received location assistance data.

A method, in certain embodiments, may include receiving a request at a user equipment from a network entity. The method may also include sending from the user equipment a response to the request. The response may comprise information about radio signal capabilities of the user equipment. In addition, the method may include receiving location assistance data from the network entity based on the sent radio signal capabilities. Further, the method may include determining signal measurements at the user equipment based on the received location assistance data.

An apparatus, in certain embodiments, may include means for receiving a request at a user equipment from a network entity. The apparatus may also include means for sending from the user equipment a response to the request. The response may comprise information about radio signal capabilities of the user equipment. In addition, the apparatus may include means for receiving location assistance data from the network entity based on the sent radio signal capabilities. Further, the apparatus may include means for determining signal measurements at the user equipment based on the received location assistance data.

According to certain embodiments, a non-transitory computer-readable medium encoding instructions that, when executed in hardware, perform a process. The process may include receiving a request at a user equipment from a network entity. The process may also include sending from the user equipment a response to the request. The response may comprise information about radio signal capabilities of the user equipment. In addition, the process may include receiving location assistance data from the network entity based on the sent radio signal capabilities. Further, the process may include determining signal measurements at the user equipment based on the received location assistance data.

According to certain other embodiments, a computer program product may encode instructions for performing a process. The process may include receiving a request at a user equipment from a network entity. The process may also include sending from the user equipment a response to the request. The response may comprise information about radio signal capabilities of the user equipment. In addition, the process may include receiving location assistance data from the network entity based on the sent radio signal capabilities. Further, the process may include determining signal measurements at the user equipment based on the received location assistance data.

### BRIEF DESCRIPTION OF THE DRAWINGS

For proper understanding of the invention, reference should be made to the accompanying drawings, wherein:

FIG. 1 illustrates an example of a flow diagram according to certain embodiments.

FIG. 2 illustrates an example of a flow diagram according to certain embodiments.

FIG. 3 illustrates a system according to certain embodiments.

### DETAILED DESCRIPTION

A location server in some communication networks may assume that all of the devices in the communication networks are capable of supporting the full system bandwidth. Using such an assumption, any device supporting OTDOA may be capable of measuring the entire PRS bandwidth. In certain embodiments, however, such as those involving IoT devices, a lower bandwidth access may be provided for. This lower bandwidth access may lead to lower accuracy of the positioning or location technology provided in the network.

Certain embodiments may allow a user equipment, such as an IoT device, to inform a network entity, such as a location server, of the radio signaling capabilities of the user equipment. The location server may then determine location assistance data to be used by the user equipment based at least in part on the radio signaling capabilities of the user equipment. The embodiments described below help to improve the accuracy of a location or position determination made by a network entity, such as a location server. These embodiments help to achieve significant improvements to the functioning of the network itself, the functioning of the user equipment interacting with the network, and/or the functioning of different network entities within the network.

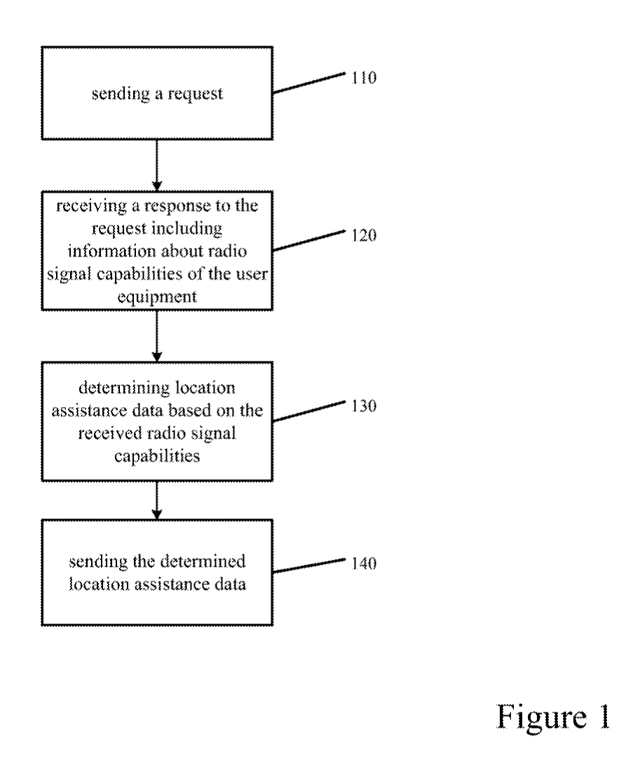

FIG. 1 illustrates a flow diagram according to certain embodiments. In particular, FIG. 1 illustrates an embodiment of a method performed by a network entity, such as a location server. In step 110, a network entity, such as a location server, sends a request to a user equipment (UE), such as an IoT device. The request, in some embodiments, may be sent as a location positioning protocol (LPP) message over the control plane. The request may also utilize a secure user plane location (SUPL) message. The user plane may be used for carrying network user traffic, while the control plane may be used for carrying signaling traffic. The request sent in step 110 may include a capability request that requests information from the UE about the radio signal or radio frequency capabilities of the UE. The information about radio signal capabilities, for example, may relate to the UE bandwidth capabilities and/or the PRS measurement capabilities or limitations of the UE.

In step 120, the network entity may receive a response from the UE that includes information about radio signal capabilities of the UE. In embodiments in which information about the bandwidth capabilities of the UE was requested, the response may include a specific UE category or other information relating to the bandwidth capability of receiving signals at the UE. For example, the UE may indicate that it is a narrowband UE or a wideband UE. Narrowband UEs, such as IoT devices, use a smaller bandwidth range than the frequency range used in wideband communications, which may utilize the entire available system bandwidth. The narrowband location, such as the narrowband frequency range within the available bandwidth, may also be included. In other embodiments, the bandwidth capabilities of the UE may include that the UE is an LTE category 1 UE or an LTE category M1 UE. Any other UE category provided for by 3GPP may also be included as part of the bandwidth capabilities sent to the network entity. The type of UE category, for example, may dictate the transmission time interval, or various characteristics of the uplink shared channel or downlink shared channel, such as maximum number of transport block bits transmitted with transmission time interval.

A single PRS can be transmitted with a specified bandwidth for a specified number of subframes per carrier. In certain embodiments, PRS measurement capabilities may be included in the information about radio signal capabilities received by the network entity, in step 120. PRS measurement capabilities may help the network entity determine PRS configuration enhancements for serving base stations and neighboring base stations, such as an enhanced NodeB (eNB), that transmit signals to the UE. For example, the PRS measurement capabilities may include a maximum number of physical resource blocks (PRBs) that can be measured in one subframe. In another example, the PRS measurement capabilities may include whether the UE supports PRS-frequency-hopping-based RSTD measurements. PRS-frequency-hopping-based RSTD measurements may be used in narrowband UEs, such as IoT devices.

The information regarding the radio signal capabilities of the UE may include any capability that can be used by the network entity to help improve or optimize the location or positioning technology of the network. In some embodiments, UE bandwidth capabilities or the PRS measurement capabilities may be explicitly indicated in the response. In other embodiments, however, the information may be implicit, meaning that the network entity may detect the UE bandwidth capabilities and/or the UE PRS measurement capabilities without an explicit indication from the UE.

For example, a R14 UE may be either a wideband UE or a narrowband UE. If all non-narrowband R14 UEs report their category to the network entity, then any R14 UE that does not send its category may be inferred to be a narrowband UE, in some embodiments. In other examples, any other type of UE may be used by the network entity to infer information relating to radio signal capabilities. In embodiments in which the UE information may be implicit, and inferred by the network entity, the amount of data that the UE transmits to the network may be reduced. Such a reduced transmission can help to further improve the battery life and/or efficiency of UEs, such as IoT devices.

The information about radio signal capabilities, in certain embodiments, may be transmitted directly from the UE to the network entity. For example, the information may be transmitted via the LPP interface enhancements in accordance with 3GPP TS 36.355. 3GPP TS 36.355 is hereby incorporated in its entirety by reference. In other embodiments, the information about the radio signal capabilities may be sent from the UE to the network entity through the mobility management entity (MME) via signal link interface enhancements in accordance with 3GPP TS 29.171. 3GPP TS 29.171 is hereby incorporated in its entirety by reference. The method of transmission from the UE to the network entity may be determined by request or by a default configuration.

In step 130, the network entity may determine location assistance data based on the radio signal capabilities received in step 120. The location assistance data may be used by the UE to determine signal measurements. For example, the location assistance data may help to delineate from which neighboring base stations the UE should use its limited narrowband to receive PRSs. Delineating the neighboring base stations by the network entity may lower location accuracy errors, and improve the location determination made by the UE. Specifically, in determining the location assistance data, the network entity may select one or more PRS configurations that match the radio signal capabilities of the UE. For example, the location access data may exclude a given neighboring base station that may be located too far away from the UE.

The assistance data may be sent to the UE, as shown in step 140, using LPP messaging, for example. The UE may then use location assistance data to determine signal measurements. Determining signal measurements using the location assistance data may allow the UE to optimize the measuring of PRSs, and later convert such measurements into the desired RSTD used by the network entity to generate the location of the user equipment. Specifically, the UE can use the assistance data in order to become better informed about the PRS configuration, and when the PRSs are expected to arrive at the UE. Upon receiving the location assistance data from the network entity, the UE may know when the PRSs are muted from certain neighboring base stations, as determined by the network entity. The network entity may assign a muting pattern, and the user equipment may be informed of the muting pattern. In other words, once the network entity, such as an eNB, mutes the PRS signal, the UE may listen for the PRS broadcast in accordance with the muting pattern.

In some embodiments, the assistance data may be related to the OTDOA. OTDOA assistance data may include reference cell information and/or neighbor cell information. The neighbor cell information may be sorted in a list of decreasing order of priority for measurements. Since the UE does not know when the network entity sent the PRS, the UE may measure when the PRS is received. The UE may then report a difference between two positioning reference signal measurements. A reference cell may be used for all of the measured differences. When the UE calculated the difference, the UE may note the time it measured the PRS of one or more neighbor cells and subtract the time measured when receiving the signal from the reference cell. When both the PRS from the one or more neighbor cell and the reference cell are sent by the eNBs at the same time, then this difference cancels out the network entity sent time. When a difference in distance is known, the UE may solve for the position if given the accurate location of all the cells included in the measurements.

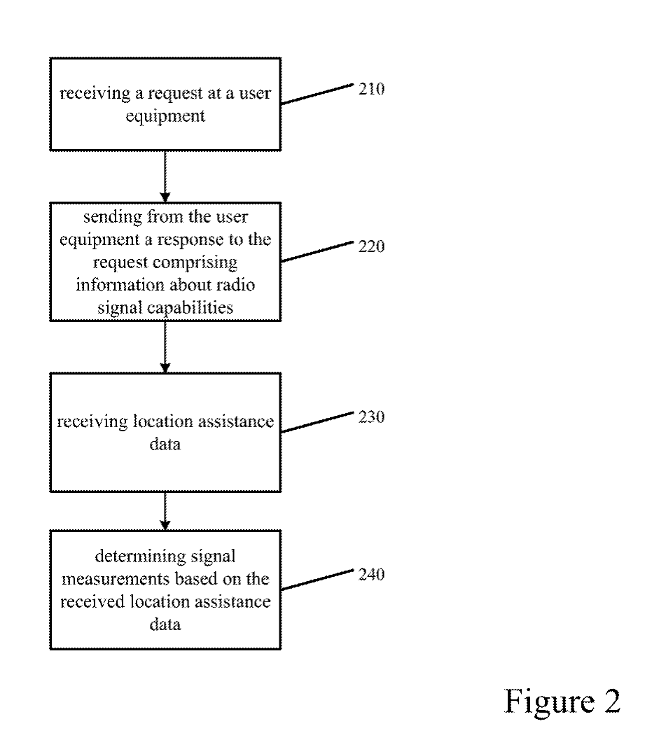

FIG. 2 illustrates a flow diagram according to certain embodiments. In particular, FIG. 2 illustrates an embodiment of a method performed by a UE, such as an IoT device. The embodiment shown in FIG. 1 and the embodiment shown in FIG. 2 may represent compatible methods of a network entity communicating with a user equipment. In step 210, the UE may receive a request from a network entity, for example the location server whose method is described in FIG. 1. The request may be received via an LPP message using a SUPL or a control plane. In step 220, the UE may send a response to the request that includes information about radio signal capabilities of the UE. The response, for example, may include the UE bandwidth capabilities or the PRS measurement capabilities of the UE.

In step 230, the UE may receive location assistance data from the network entity based on the sent radio signal capabilities. The UE may then determine signal measurements based on the location assistance data, as shown in step 240. In other words, the UE may use the location assistance data to optimize measuring PRSs, and later convert such measurements into the desired RSTD used by the location server. In some embodiments, the location assistance data may be used by the UE to improve RSTD measurements, thereby improving the accuracy of the determined UE location.

Below is an example of an embodiment that utilizes the LPP in OTDOA. A request may be sent from the network entity, for example a location server, to a UE, for example an IoT device. The request may include a capability request that can be added by the location server to the request sent to the UE. In response, the UE can respond with the requested capability information. The UE may add the capability information to an OTDOA information element (IE) in the LPP. Based on the received capability information, the location server may know information for assistance data optimization.

In certain embodiments, the information about the radio signaling capability of the UE may include that the UE is either a narrowband UE, such as an IoT device, or a wideband UE. If the information indicates that the UE is narrowband, the network entity may optimize the assistance data for narrowband conditions. On the other hand, if the information indicates that the UE is wideband, optimization of the assistance data may not be needed. In some embodiments, information about the radio signaling capability of the UE may also include a maximum number of PRBs for RSTD measurements. This can inform the network entity that the UE supports up to the indicated number of PRBs for RSTD measurements. For example, a network may choose all available 50 PRBs for OTDOA. For a narrowband UE, such as an IoT device, the network entity may choose a subset or portion of the 50 PRBs for OTDOA. The PRBs of the PRSs may be statically configured by base stations, such as eNBs, which communicate with the UE. The network entity, in some embodiments, may therefore only choose from the PRS that have been configured by the base stations.

In other embodiments, the information about the radio signaling capability of the UE may include a maximum number of PRBs in one subframe for RSTD measurement. This maximum number can indicate to the network entity the maximum number of supported PRBs in one subframe for RSTD measurement at the UE. The information may also include whether or not the UE has the capability to support PRS-frequency-hopping-based RSTD measurements.

The embodiments described in FIGS. 1 and 2 help to improve the accuracy of the location determination made by the network entity, such as a location server. Location accuracy may depend on physically possible accuracy under ideal conditions and/or actual observed accuracy without error corrections. In some embodiments, OTDOA performance may depend on error measurements that may be corrected. For example, some errors may be due to a timing alignment error in the serving or neighboring base stations, or from the timing of the user equipment.

In other embodiments, an error may also be caused by non-line of sight (NLOS) propagation. Some embodiments may help to limit the effects of NLOS propagation by allowing for up to 72 neighboring base stations on one frequency, as described in 3GPP TS 36.355. 3GPP TS 36.355 is incorporated by reference herein. While adding neighboring base stations may improve the ability of the network entity to detect and discard bad measurements, in some embodiments the additional neighbors may not correct for the NLOS errors.

In certain embodiments, a lower bandwidth UE may be physically restricted from higher access measurements. The location accuracy determined by the UE may therefore benefit from improved location access data that may be based at least in part on the radio signal capabilities of the UE. In other words, the embodiments illustrated in FIGS. 1 and 2 describe utilizing machine learning to determine the optimal neighboring base stations suited to provide PRSs to an IoT device. By selecting the optimal neighboring base stations list, from which the UE may receive PRSs, the UE may remove accuracy errors, thereby improving location or position technology of the network. To optimize the location accuracy, the network entity may utilize the radio signal capabilities of the UE and/or limitations of the UE when selecting location access data. The information contained in the location access data, for example a list of the best neighboring base stations, may be used by the UE to minimize any errors that may lead to an inaccurate determination of the location of the UE. The location assistance data, in certain embodiments, may include a reference cell and a list of one or more neighboring cells or base stations from which the user equipment measures positioning reference signals.

When the network entity receives an indication that a UE is an IoT device, the network entity may use the indication to determine the neighboring base station list from which the UE may receive PRSs. In some embodiments, the selection of the neighboring list may be modified to represent known PRS hearability of the IoT. The network entity, for example, may exclude any neighboring base stations that are more than a given distance away from the UE.

In another example, over a given period the network entity may determine that the narrowband UE cannot hear certain physical cell identifiers (PCIs). In some embodiments, the radio signaling capabilities of the UE may not allow it to receive the PCIs. The network entity may have the option of choosing the neighbors that avoid PCI combinations that are known to reduce accuracy, such as those that cannot be heard by the UE. In other words, the UE may listen for the PRS based on the PCI received from the network entity or the location server. In certain embodiments, the network entity may decide to exclude small cells that only broadcast narrow band PRSs from the neighboring base station list sent to a wideband UE.

In a further example, if the information about the radio signal capabilities of the UE indicates that the UE is wideband, optimization of the assistance data may not be needed. In other embodiments, optimization of the assistance data may still be used to exclude PRSs that are optimized for narrowband conditions.

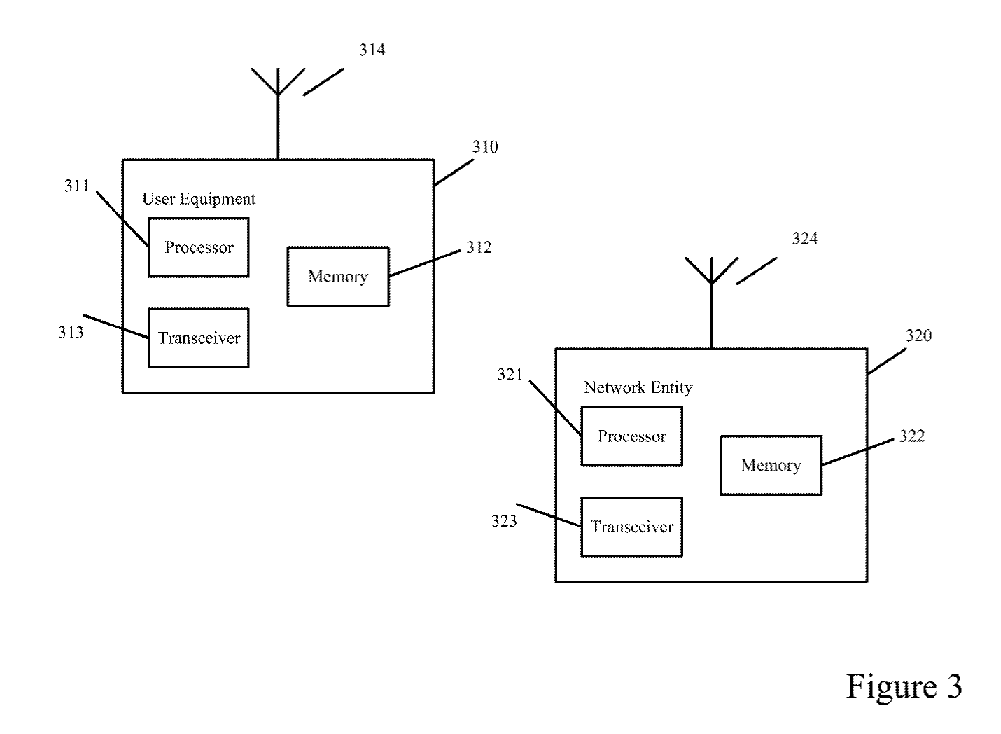

FIG. 3 illustrates a system according to certain embodiments. It should be understood that each signal or block in FIGS. 1 and 2 may be implemented by various means or their combinations, such as hardware, software, firmware, one or more processors and/or circuitry. In one embodiment, a system may include several devices, such as, network entity 320 or UE 310. The system may include more than one UE 310 and more than one network entity 320, although only one network node and one user equipment are shown for the purposes of illustration. The network entity may be, for example, a location server, Evolved Serving Mobile Location Center (E-SMLC), SUPL Location Platform (SLP), a location beacon, a network node, access node, a base station, a 5G NodeB, an eNB, host, or any of the other server or network node discussed herein.

Each of these devices may include at least one processor or control unit or module, respectively indicated as 311 and 321. At least one memory may be provided in each device, and indicated as 312 and 322, respectively. The memory may include computer program instructions or computer code contained therein. One or more transceiver 313 and 323 may be provided, and each device may also include an antenna, respectively illustrated as 314 and 324. Although only one antenna each is shown, many antennas and multiple antenna elements may be provided to each of the devices. Other configurations of these devices, for example, may be provided. For example, network entity 320 and UE 310 may be additionally configured for wired communication, in addition to wireless communication, and in such a case antennas 314 and 324 may illustrate any form of communication hardware, without being limited to merely an antenna.

Transceivers 313 and 323 may each, independently, be a transmitter, a receiver, or both a transmitter and a receiver, or a unit or device that may be configured both for transmission and reception. The transmitter and/or receiver (as far as radio parts are concerned) may also be implemented as a remote radio head which is not located in the device itself, but in a mast, for example. The operations and functionalities may be performed in different entities, such as nodes, hosts or servers, in a flexible manner. In other words, division of labor may vary case by case. One possible use is to make a network node deliver local content. One or more functionalities may also be implemented as virtual application(s) in software that can run on a server.

A user device or user equipment 310 may be an IoT device, a machine type communication device, a mobile station (MS) such as a mobile phone, smart phone, or multimedia device, a computer, such as a tablet, provided with wireless communication capabilities, personal data or digital assistant (PDA) provided with wireless communication capabilities, portable media player, digital camera, pocket video camera, navigation unit provided with wireless communication capabilities or any combinations thereof. In other embodiments, the user equipment may be replaced with a machine communication device or an IoT device that does not require any human interaction, such as a sensor or a meter.

In some embodiments, an apparatus, such as a network entity, may include means for carrying out embodiments described above in relation to FIGS. 1 and 2. In certain embodiments, at least one memory including computer program code can be configured to, with the at least one processor, cause the apparatus at least to perform any of the processes described herein.

Processors 311 and 321 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors.

For firmware or software, the implementation may include modules or unit of at least one chip set (for example, procedures, functions, and so on). Memories 312 and 322 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory or data storage entity is typically internal but may also be external or a combination thereof, such as in the case when additional memory capacity is obtained from a service provider. The memory may be fixed or removable.

The memory and the computer program instructions may be configured, with the processor for the particular device, to cause a hardware apparatus such as network entity 320 or UE 310, to perform any of the processes described above (see, for example, FIGS. 1 and 2). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments may be performed entirely in hardware.

Furthermore, although FIG. 3 illustrates a system including a network entity 320 and UE 310, certain embodiments may be applicable to other configurations, and configurations involving additional elements, as illustrated and discussed herein. For example, multiple user equipment devices and multiple network entities may be present, or other nodes providing similar functionality, such as nodes that combine the functionality of a user equipment and an network entity, such as a relay node. The UE 310 may likewise be provided with a variety of configurations for communication other than communication network entity 320. For example, UE 310 may be configured for device-to-device communication, machine-to-machine communication, or vehicle-to-vehicle communication.

Certain embodiments can provide a method, apparatus, means for, or a computer product that allow a network entity to become aware of the radio signal capabilities of the UE. The network entity may then use the capabilities of the UE to improve the determined location access data, including selection of the PRS neighboring base stations. This can improve the measurements received by the UE, thereby improving the location accuracy of the UE, such as the OTDOA location accuracy. These embodiments help to achieve significant improvements to the functioning of the network, the functioning of the user equipment interacting with the network, and/or the functioning of different network entities within the network.

The features, structures, or characteristics of certain embodiments described throughout this specification may be combined in any suitable manner in one or more embodiments. For example, the usage of the phrases “certain embodiments,” “some embodiments,” “other embodiments,” or other similar language, throughout this specification refers to the fact that a particular feature, structure, or characteristic described in connection with the embodiment may be included in at least one embodiment of the present invention. Thus, appearance of the phrases “in certain embodiments,” “in some embodiments,” “in other embodiments,” or other similar language, throughout this specification does not necessarily refer to the same group of embodiments, and the described features, structures, or characteristics may be combined in any suitable manner in one or more embodiments.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

According to a first embodiment, a method may include sending a request from a network entity to a user equipment. The method may also include receiving a response to the request from the user equipment. The response comprises information about radio signal capabilities of the user equipment. In addition, the method may include determining location assistance data based on the received radio signal capabilities. The location assistance data may be used by the user equipment to determine signal measurements.

In a variant, the signal measurements may include a reference signal time difference measurement.

In another variant, the method may include receiving at the network entity the signal measurements from the user equipment.

In yet another variant, the method may include determining at the network entity a location of the user equipment based on the signal measurements.

In a variant, the method may include sending to the user equipment from the network entity the determined location assistance data.

In a further variant, the location of the user equipment may be determined via an observed time difference of arrival.

In an additional variant, the location assistance data may include a reference cell and a list of at one or more neighboring base stations from which the user equipment measures positioning reference signals.

In another variant, the method may include determining at the network entity a muting pattern for the positioning reference signal.

In yet another variant, the information about the radio signal capabilities of the user equipment may include at least one of an indication of bandwidth capabilities of the user equipment or an indication of positioning reference signal measurements capabilities of the user equipment.

In another variant, the bandwidth capabilities of the user equipment may include whether the user equipment is a narrowband user equipment or a wideband user equipment.

In yet another variant, the positioning reference signal measurements capabilities of the user equipment may include at least one of a maximum number of physical resource blocks that are capable of being measured in a subframe for a reference signal time difference measurement.

In a variant, the method may include detecting from the information about the radio signal capabilities the bandwidth capabilities of the user equipment.

In another variant, the network entity may include a location server.

In yet another variant, the location request and the response to the location request may be transmitted via a location positioning protocol.

In a variant, the user equipment may include a machine type communication user equipment.

According to a second embodiment, a method may include receiving a request at a user equipment from a network entity. The method may also include sending from the user equipment a response to the request. The response may comprise information about radio signal capabilities of the user equipment. In addition, the method may include receiving location assistance data from the network entity based on the sent radio signal capabilities. Further, the method may include determining signal measurements at the user equipment based on the received location assistance data.

In a variant, the method may include sending the network entity the signal measurements based on the received location assistance data.

In another variant, the signal measurements may include a reference signal time difference measurement.

In a further variant, the method may include muting a positioning reference signal from at least one neighboring base station based on the determined assistance data.

In another variant, the location of the user equipment may be determined via an observed time difference of arrival.

In yet another variant, the information about the radio signal capabilities of the user equipment may include at least one of an indication of bandwidth capabilities of the user equipment or an indication of positioning reference signal measurements capabilities of the user equipment.

In an additional variant, the network entity may include a location server.

In a variant, the user equipment may include a machine type communication.

In yet another variant, the location request and the response to the location request may be transmitted via a location positioning protocol.

According to a third and a fourth embodiment, an apparatus can include at least one processor and at least one memory and computer program code. The at least one memory and the computer program code can be configured to, with the at least one processor, cause the apparatus at least to perform the method according to the first and second embodiments respectively, and any of their variants.

According a fifth and a sixth embodiment, an apparatus can include means for performing the method according to the first and second embodiments respectively, and any of their variant.

According to a seventh and an eighth embodiment, a computer program product may encode instructions for performing a process including the method according to the first and second embodiments respectively, and any of their variants.

According to a ninth and a tenth embodiment, a non-transitory computer-readable medium may encode instructions that, when executed in hardware, perform a process including the method according to the first and second embodiments respectively, and any of their variants.

Partial Glossary

| | |
|---|---|
| 3GPP | Third Generation Partnership Project |
| LTE | Long Term Evolution |
| OTDOA | Observed Time Difference of Arrival |
| RSTD | Reference Signal Time Difference |
| IoT | Internet of Things |
| UE | User Equipment |
| LPP | Location Positioning Protocol |
| SUPL | Secure User Plane Location |
| PRBs | Physical Resource Blocks |
| NLOS | Non-Line of Sight |
| PRS | Positioning Reference Signal |

We claim:

1. A method comprising:
sending a request from a network entity to a user equipment;
receiving a response to the request from the user equipment, wherein the response comprises information about radio signal capabilities of the user equipment; and
determining location assistance data based on the received radio signal capabilities.

2. The method according to claim 1, further comprising:
sending to the user equipment from the network entity the determined location assistance data.

3. The method according to claim 1, further comprising:
receiving at the network entity signal measurements from the user equipment based on the determined location assistance data.

4. The method according to claim 3, wherein the signal measurements comprise a reference signal time difference measurement.

5. The method according to claim 3, further comprising:
determining at the network entity a location of the user equipment based on the signal measurements.

6. The method according to claim 1, wherein the location assistance data comprises a reference cell and a list of at one or more neighboring base stations from which the user equipment measures positioning reference signals.

7. The method according to claim 1, further comprising:
determining at the network entity a muting pattern for the positioning reference signal.

8. The method according to claim 1, wherein the information about the radio signal capabilities of the user equipment comprises at least one of an indication of bandwidth capabilities of the user equipment or an indication of positioning reference signal measurements capabilities of the user equipment.

9. The method according to claim 8, wherein the bandwidth capabilities of the user equipment comprises whether the user equipment is a narrowband user equipment or a wideband user equipment.

10. The method according to claim 8, wherein the positioning reference signal measurements capabilities of the user equipment comprises at least one of a maximum number of physical resource blocks that are capable of being measured in a subframe for a reference signal time difference measurement.

11. The method according to claim 1, further comprising:
detecting from the information about the radio signal capabilities the bandwidth capabilities of the user equipment.

12. The method according to claim 1, wherein the location of the user equipment is determined via an observed time difference of arrival.

13. A method comprising:
receiving a request at a user equipment from a network entity;
sending from the user equipment a response to the request, wherein the response comprises information about radio signal capabilities of the user equipment;
receiving location assistance data from the network entity based on the sent radio signal capabilities; and
determining signal measurements at the user equipment based on the received location assistance data.

14. The method according to claim 13, further comprising:
sending from the user equipment to the network entity the signal measurements based on the received location assistance data.

15. The method according to claim 13, wherein the signal measurements comprise a reference signal time difference measurement.

16. The method according to claim 13, wherein the information about the radio signal capabilities of the user equipment comprises at least one of an indication of bandwidth capabilities of the user equipment or an indication of positioning reference signal measurements capabilities of the user equipment.

17. An apparatus comprising:
at least one processor; and
at least one memory and computer program code,
wherein the at least one memory and the computer program code can be configured to, with the at least one processor, cause the apparatus at least to:
send a request to a user equipment;
receive a response to the request from the user equipment, wherein the response comprises information about radio signal capabilities of the user equipment; and
determine location assistance data based on the received radio signal capabilities.

18. The apparatus of claim 17, wherein the at least one memory and the computer program code can be configured to, with the at least one processor, cause the apparatus at least to send to the user equipment from the network entity the determined location assistance data.

19. The apparatus of claim 17, wherein the at least one memory and the computer program code can be configured to, with the at least one processor, cause the apparatus at least to receive at the network entity signal measurements from the user equipment based on the determined location assistance data.

20. The apparatus of claim 19, wherein the signal measurements comprise a reference signal time difference measurement.
